(19) United States
(12) Patent Application Publication
(10) Pub. No.: US 2024/0385951 A1
(43) Pub. Date: Nov. 21, 2024

(54) SYSTEM AND METHODS FOR CHARACTERIZING AUTHENTIC USER EXPERIENCES

(71) Applicant: Wevo, Inc., Boston, MA (US)

(72) Inventors: Alexander Barza, Cambridge, MA (US); Charlie Hoang, Boston, MA (US); Frank Chiang, Boston, MA (US); Dustin Garvey, Exeter, NH (US); Laryssa Costa De Souza, Boston, MA (US); Janet Muto, Boston, MA (US); Nitzan Shaer, Boston, MA (US); Jon Andrews, Boston, MA (US); Nick Montaquila, Boston, MA (US)

(73) Assignee: Wevo, Inc., Boston, MA (US)

(21) Appl. No.: 18/317,694

(22) Filed: May 15, 2023

(51) Int. Cl. G06F 11/36; G06F 8/41

(52) U.S. Cl. CPC G06F 11/3688; G06F 8/433

(57) ABSTRACT

Techniques are described herein for testing and characterizing user experiences with digital assets. Embodiments include a digital experience testing system for running usability tests with respect to user interface designs. The runtime testing environment may use a set of one or more compiled prototypes to test various facets of a user experience including what respondents do when interacting with a digital asset and how the experience engages the respondents' emotions. The digital experience testing system may analyze, enrich, synthesize, and/or otherwise process the results of one or more usability tests, based on the tracked user interactions, to provide guidance on user interface design optimizations.

### TECHNICAL FIELD

The present disclosure relates, generally, to user experience testing. In particular, the present disclosure relates to techniques for generating, compiling, executing, and processing usability tests.

### BACKGROUND

User experience (UX) design encompasses tools and applications for optimizing how users interact with a system, which may be comprised of physical and/or digital interfaces. In the space of digital experiences, usability testing tools allow designers and developers to create a design mockup or model of a user interface, also referred to as a prototype. User interface prototypes may comprise a set of frames that represent individual screens or pages of an app or website. The frames may be linked together with interactive hotspots or buttons, which may trigger actions such as navigating to another screen. Creating a prototype of a user interface allows designers to test and refine user interface designs before the interface is fully developed or deployed.

Generally, user interface prototypes are tightly coupled to the testing tools used to create the prototypes. Different prototype development tools provide varying suites of capabilities that produce prototypes in a proprietary format. As a result, functionality of the prototypes may be limited based on which specific suite of capabilities was used to create the prototype. By constraining developers to the functionality of a particular ecosystem, many insights into the usability of a particular website or application may be overlooked or otherwise missed, which may negatively impact the overall user interface design. Additionally, many prototypes are static in nature, containing a set of scalable vector graphics demonstrating how a user interface would look, but fail to precisely gauge how a prototypical user would functionally interact with the user interface design.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a scalable system architecture for characterizing user experiences in accordance with some embodiments;

FIG. 2 illustrates an example dataflow diagram for compiling normalized primitive files to generate prototypes in accordance with some embodiments;

FIG. 3 illustrates an example dataflow diagram for performing multiple passes using different prototypes to capture various facets of a user experience in accordance with some embodiments;

FIG. 4 illustrates an example set of prototype images that are decorated based on the results of running multi-pass usability tests in accordance with some embodiments;

FIG. 5 illustrates an example set of operations for programmatically changing the flow of a prototype in accordance with some embodiments; and

FIG. 6 illustrates a computer system in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. General Overview

Techniques are described herein for generating, compiling, executing, enriching, and synthesizing digital experience testing. The techniques may automate one or more aspects of digital experience testing, increasing the scalability of user experience (UX) testing systems and methodologies. The techniques may further provide insights into UX test results that are not readily apparent from the raw result data. The insights may be used to render user interfaces and/or to trigger other system actions, which may optimize product design feedback, analysis, and development process flows.

Digital experience testing tools may provide insights about the positives and negatives of an environment that is similar or identical to an existing or eventual product environment. Embodiments herein include a digital experience testing system for running usability tests with respect to a product or prototype. The runtime testing environment may use a set of one or more compiled prototypes to test various facets of a user experience including what respondents do when interacting with a digital asset and how the experience engages the respondents' emotions. The digital experience testing system may analyze, enrich, synthesize, and/or otherwise process the results of one or more usability tests, based on the tracked user interactions, to provide guidance on user interface design optimizations.

In some embodiments, the testing system includes an extensible framework that may export and compile prototypes from multiple sources. Prototype primitives may conform to varying formats and file types, depending on the development tool used in its creation. Additionally or alternatively, a prototype primitive may also be generated by crawling a live website or application. Through normalization, the testing system may provide a means of comparison between multiple live sites, a live site and a prototype, and/or multiple prototypes. Thus, designers may determine the test performance between a live site and one or more competitor's live sites, a prototype of a new design and a design already developed and deployed in a live site, and/or alternative prototype designs. The testing system may provide insights on why one design performed better than another including identifying (a) aspects of the design that performed better relative to other designs, (b) aspects of the design that underperformed relative to other designs; and (c) the reasons why the identified aspects exceled or underperformed.

In some embodiments, the testing system normalizes primitives from different sources into a uniform format whereby the files may be compiled into different configurations for different purposes. The testing system may apply a single or multi-pass method at runtime using different compiled prototypes to capture various facets of a digital experience. The testing system may decorate one or more pages of a user interface with annotations, recommendations, and/or other elements based on the analysis performed in the multi-pass method. Additionally or alternatively, the testing system may execute or trigger other actions based on the results, such as programmatically changing a flow in a prototype and/or updating user interface elements associated with the prototype.

In some embodiments, the testing system captures how a digital experience engages users' emotions. The testing system may apply a multi-pass method using two or more compiled prototypes including a first compiled prototype for a first pass to capture what a user does and a second compiled prototype for a second pass to capture how a user feels. The information tested and captured from each pass may be combined and aggregated to render an analytic report that indicates how users engage with an interface, what the users are feeling at various points in the engagement, and usability statistics associated with the user engagement. The unified output may be used to decorate a user interface or prototype with insights identifying positive and/or negative aspects of the user interface design. Additionally or alternatively, the testing system may use the unified output to execute or trigger other operations, such as recommending and/or applying updates to the user interface design.

Additionally or alternatively, the testing system may capture other usability attributes with respect to a given pass or by applying an additional pass. For example, the testing system may track whether a respondent is consistently mis-clicking or getting stuck with respect to a particular task. In response, the testing system may execute one or more actions, such as prompting the user with questions to help understand why, providing a hint for progressing with the task, resetting or fast forwarding the respondent's progress by jumping to another point in the task flow, ending the usability test, and/or redirecting the respondent to a different user experience test. The framework may allow designers to specify other custom actions, which the compiler may embed into the prototypes that are used to run the usability tests.

One or more embodiments described in this Specification and/or recited in the claims may not be included in this General Overview section.

### 2. System Architecture

Embodiments herein include a digital experience test framework whereby developers, designers, and/or other users may create user interface prototypes for performing usability tests. A user interface prototype refers to an interactive mockup or model of a website or application that simulates how users would interact with the website or application in a live environment. A prototype may include a subset of the functions of a finalized version of the website or application, allowing designers to demonstrate the flow and functionality of key elements of a design and test the user experience before the final product is built. Additionally or alternatively, a prototype may further include embedded code for programmatically testing and evaluating user experiences based on tracked interactions between respondents and the interactive model.

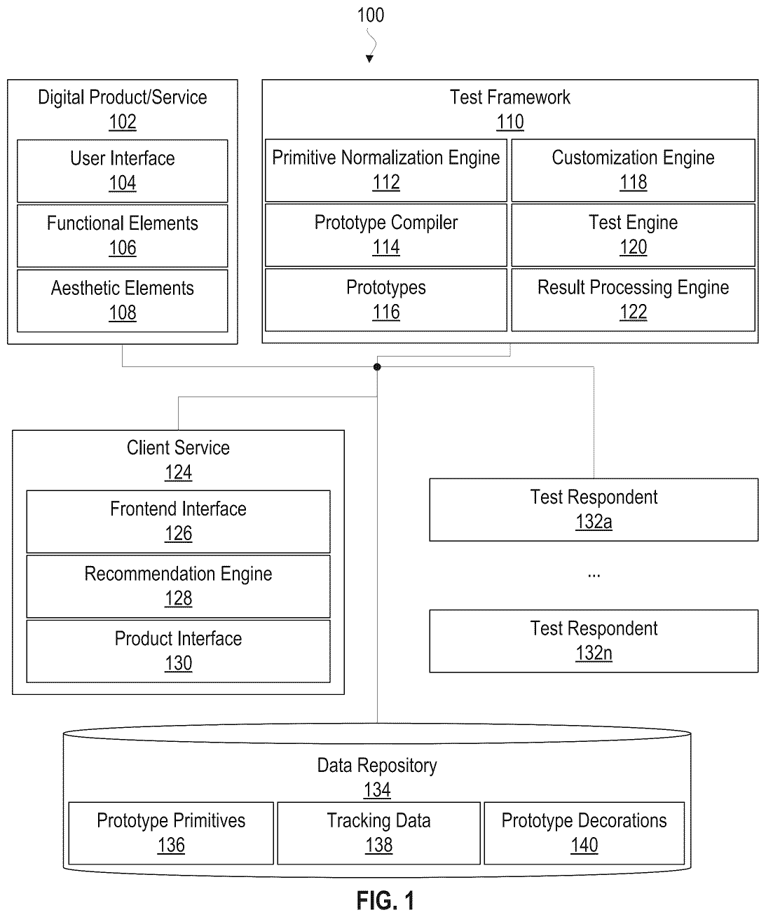

FIG. 1 illustrates a scalable system architecture for characterizing user experiences in accordance with some embodiments. As illustrated in FIG. 1, system architecture 100 includes digital product 102, test framework 110, client service 124, test respondents 132a-n, and data repository 134. In some embodiments, system architecture 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Digital product 102 refers to a good or service that exists in a digital form. Examples include websites, mobile applications, cloud services, digital media, and/or other digital assets. Digital product 102 includes user interface 104 for interacting with one or more users. In some embodiments, user interface 104 renders a set of user interface elements and receives input via the rendered user interface elements. A user interface for a digital product 102 may include a graphical user interface (GUI), a command line interface (CLI), an application programming interface (API), a haptic interface, and/or a voice command interface. Example user interface elements include checkboxes, radio buttons, dropdown lists, list boxes, buttons, toggles, text fields, date and time selectors, command lines, sliders, pages, and forms.

In some embodiments, digital product 102 includes functional elements 106 and aesthetic elements 108, which may affect the user experience with respect to digital product 102. Functional elements 106 may include user interface controls through which the user may perform tasks using digital product 102 and/or affect the output of digital product 102. Functional elements 106 may further comprise backend processes and/or systems with which a user does not directly interact, but which may affect a user's experience with digital product 102, such as a perceived responsiveness or quality of digital product 102. Aesthetic elements 108 may generally comprise nonfunctional components of digital product 102 including the look and feel of user interface 104 and/or other visual design elements of digital product 102.

Test framework 110 includes components for generating prototypes and executing usability tests. A usability test in this context refers to a test for capturing quantitative and/or qualitative data relating to various facets of a user experience with a prototype, which may include a mockup or model of user interface 104. As previously noted, user interface 104 may not have been fully developed at the time a prototype is generated. However, in other cases, user interface 104 may have been fully implemented and even deployed, such as in the case of a live website or mobile app. Test framework 110 may comprise applications, tools, and/or processes for evaluating the performance of various facets of one or more user experiences with digital product 102 based on tracked user interactions with one or more prototypes and/or responses to questions/prompts issued to test respondents. The components may include primitive normalizer 112, prototype compiler 114, prototypes 116, customization engine 118, test engine 120, and result processing engine 122.

Primitive normalization engine 112 generates normalized primitives for compilation by prototype compiler 114. A primitive in this context refers to a basic design element or building block that may be used to create a mockup or model of a user interface design. For example, a primitive may include visual elements, such as shapes and images, which may be combined to represent the design of a webpage or application page. Primitives may be customized in a variety of ways, including changing the size, color, stroke width, and opacity of the element. A primitive may be combined with one or more other primitives to create more complex designs and shapes. Primitives allow designers to quickly create basic design elements without requiring more advanced design skills or hard coding of the underlying application logic. A set of primitives may represent the overall look and feel of a website or application interface. The set of primitives may further encapsulate some basic functions that trigger actions when selected (e.g., clicked on or selected via a touch interface) by a user, such as navigating to a different page, generating a pop-up window, presenting a user prompt, or executing a function that simulates the experience of a fully developed version of the interface.

The source of a prototype primitive may vary depending on the implementation. A designer may use one or more prototype development tools to generate prototype designs using different standards and formats. For example, some prototype development tools may generate a static prototype that contains image files, such as scalable vector graphics, with no interactivity besides scrolling between different pages. Other prototype development tools may provide more interactivity, such as the ability to add hotspots, page transitions, and animations. Thus, the specific manner in which a mockup or model is represented and encoded may vary from source to source. Primitive normalization engine 112 may export the prototype files generated by the prototype development tools and normalize the primitives of each prototype to a format that is consumable by prototype compiler 114. Additionally or alternatively, prototype primitives may be generated from live websites or applications to create a mockup or model of the user interface.

Prototype compiler 114 compiles a set of normalized primitives into one or more prototypes 116. In some embodiments, prototype compiler 114 injects code to extend the functionality of primitive components in the compilation process. For example, prototype compiler 114 may add code for tracking clicks during a runtime test, tracking task progress, generating user prompts, measuring user sentiment, and/or capturing other usability information associated with a prototype. Prototype compiler 114 may generate different compiled prototypes for different purposes, and the code that is injected by the compiler may vary between different compiled prototypes.

As previously noted, prototypes are mockups or models of a user interface, which may not have been fully developed yet. The amount of detail included in a prototype may vary depending on the particular implementation. In some cases, the prototype may have a look and feel that simulates what a fully developed website would look like. Thus, the prototype may have an identical or nearly identical look and feel. In other cases, a prototype may be a wireframe, which may be designed using basic shapes and placeholders for content without including detailed visual design elements. The wireframe may define the basic structure of digital product 102, including its layout, content hierarchy, navigation, and user flow. Wireframes may serve as a starting point for more detailed design work, such as creating high-fidelity mockups.

Customization engine 118 may customize the configurations parameters used to generate prototypes based on user input from designers or other users. For example, users may define survey questions, user prompts, task flows, and/or other parameters. The custom settings may affect the manner in which prototype compiler 114 generates compiled prototypes, including the code injected into a given prototype, the types of prototypes that are compiled, and/or the number of prototypes generated. Thus, designers may be provided with a level of control over how usability tests are run.

Test engine 120 comprises a runtime environment for executing usability tests using prototypes 116. At runtime, test engine 120 may render and present a page from the mockup or model of a prototype to a test respondent, such as test respondent 132a or 132n. Test engine 120 may further execute code that has been injected into a prototype, which may trigger various functions such as navigating between different pages, presenting a pop-up window, tracking click events, prompting respondents for feedback, resetting or fast forwarding task progress, and/or other functions for capturing information about one or more facets of a user experience. Test engine 120 may comprise an interface through which test respondents 132a-n may interact with a clickable and interactive prototype. The interface may further present questions, prompts, pop-ups and/or other interface elements to capture additional information from a respondent about the prototype design.

Result processing engine 122 aggregates and analyzes test results across different test respondents. In some embodiments, result processing engine 122 identifies regions and/or components within a prototype design that have drawn the most positive and/or negative attention. Result processing engine 122 may decorate a prototype frame/image with analytical information identifying which parts of the design were positively received and/or negatively received and the reasons for the user's positive or negative experiences. Additionally or alternatively, result processing engine 122 may decorate a prototype image with recommendations to improve specific parts of the design, performance comparisons with one or more other prototypes, and/or other usability statistics based on the tracked interactions between respondents and the prototype. Result processing engine 122 may execute or trigger other actions based on the test results, such as performing automatic updates to a user interface design to address negative feedback from test respondents, prioritizing actions in an analyst pipeline (e.g., by sorting items by number of clicks and/or sentiment), and triggering alert notifications as results are updated. The analytics may isolate what areas of a user interface are problematic and what areas are performing well, allowing resources to be focused on targeting areas that would benefit most from an update.

Test respondents 132a-n are users that take usability tests by interacting with one or more compiled prototypes. Test respondents 132a-n may be fielded by a panel provider or another service, which may redirect the respondent using a uniform resource locator (URL) linked to the test. For example, a visitor to a website that satisfies a set of qualification criteria may be prompted to select a hyperlink to begin a usability test. The respondent may use a client application, such as a web browser or mobile app, to take the test and interact with a prototype.

Client service 124 comprises applications, tools and systems used by product designers and/or third-party service providers that run specialized UX tests. In some embodiments, client service 124 comprises frontend interface 126, recommendation engine 128, and product interface 130. Frontend interface 126 may comprise a user interface for presenting analytics, recommended actions, and/or other information based on the predictions. For example, frontend interface 126 may generate and render interactive charts that allow a user to compare usability statics for different prototypes and/or live web applications. The user may view which facets are underperforming relative to peer products, the reasons for underperformance, and recommended actions to address the problems. Additionally or alternatively, the user may view decorated versions of a prototype that isolate the areas of a design that are receiving the most negative and/or positive attention, including the most common reasons for the attention.

Recommendation engine 128 may comprise logic for generating recommendations. For example, recommendation engine 128 may determine which facets are underperforming and which solutions are predicted to improve performance with respect to the facet. Recommendation engine 128 may use rules and/or machine-learning to generate the recommendations. For instance, recommendation engine 128 may train a machine learning model, such as a neural network, to learn patterns within digital interface designs that are associated with negative and positive respondent sentiment. Recommendation engine 128 may apply the trained model to a set of test results to recommend product updates that are predicted to improve the product's usability statistics.

Product interface 130 may be communicatively coupled to digital product 102 and allow client service 124 to invoke and/or execute functions on digital product 102. For example, product interface 130 may include an API endpoint to send requests to a software application or a service to execute a requested change in the user interface. As another example, product interface 130 may invoke an editor to change a webpage associated with digital product 102. Additionally or alternatively, product interface 130 may execute the functions against one of prototypes 116. The requests and functions that are invoked may be directed to improving underperforming facets of a prototype design based on the analytic results determined from usability testing.

Data repository 134 stores and fetches data including prototype primitives 136, tracking data 138, and prototype decorations 140. In some embodiments, data repository 134 is any type of storage unit and/or device (e.g., a file system, database, collection of tables, or any other storage mechanism) for storing data. Further, data repository 134 may include multiple different storage units and/or devices. The multiple different storage units and/or devices may or may not be of the same type or located at the same physical site. Further, data repository 134 may be implemented or executed on the same computing system as one or more other components of system 100. Alternatively or additionally, data repository 134 may be implemented or executed on a computing system separate from one or more other system components. Data repository 134 may be communicatively coupled to remote components via a direct connection or via a network.

The components illustrated in FIG. 1 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

One or more components illustrated in FIG. 1, may be implemented as a cloud service or a microservice application. Tenants may subscribe to a cloud service to compile prototypes, run usability tests, view usability test results and analytics, and implement recommended actions to improve the product design. Additional embodiments and examples relating to computer networks are described below in Section 7, titled Computer Networks and Cloud Networks. Additional embodiments and Examples Relating to Computer Networks are described below in Section 8, titled Microservice Applications.

### 3. Export and Compilation of Prototypes

As previously noted, primitive normalization engine 112 may export and normalize a set of prototype primitives from one or more sources. The normalization process may generally include identifying a set of one or more elements within one or more source files that map to a primitive component and converting the set of one or more elements to a normalized format compatible with prototype compiler engine 114. The mapping and conversion may vary depending on the type of source involved in the development of the prototype.

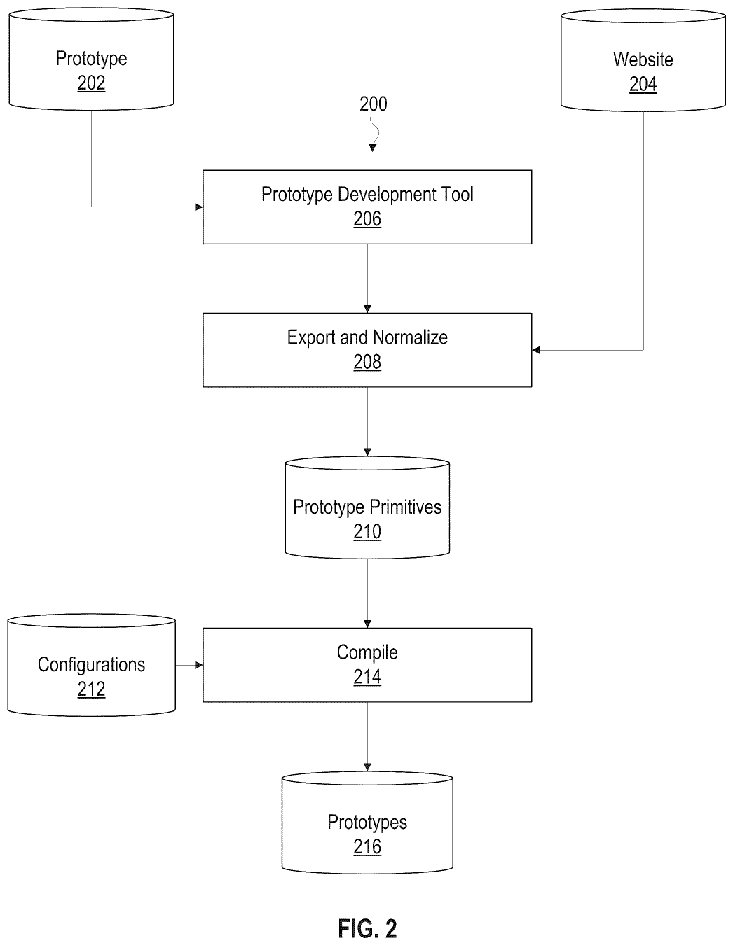

FIG. 2 illustrates example dataflow diagram 200 for compiling normalized primitive files to generate prototypes in accordance with some embodiments. Referring to dataflow diagram 200, prototype 202 is created using prototype development tool 206. As previously noted, primitive normalization engine 112 may support generating normalized primitives from a variety of different sources, which may use different formats and standards to create mockups or user interface models. For example, some sources may define visual elements of a mockup using scalable vector graphics (SVG), which is a vector image format that uses an extensible markup language (XML) to define two-dimensional graphics. A frame of a prototype may be represented using one or more SVG objects. Other sources may use other vector graphic and/or image formats to define the visual elements of a mockup. As another example, sources may define functional elements, such as navigation flows that are linked to visual elements, to create a clickable and interactive prototype. As with the visual elements, the functional elements of a prototype may be defined using different code and formats, which may vary depending on the particular tool used by the user interface designer to create the mockup or model.

Once the prototype has been developed using prototype development tool 206, export and normalize operation 208 is performed to create prototype primitives 210. In some embodiments, prototype development tool 206 may have a native export function that stores the prototype code and data in one or more files. The file formats may vary depending on the tool used. Primitive normalization engine 112 may parse the exported file to identify the visual components of a mockup or model and any associated functions. For example, primitive normalization engine 112 may parse the file to identify images, buttons, hotspots, overlays, and/or other visual elements of a mockup website. Primitive normalization engine 112 may further parse the file to determine navigation functions associated with the visual elements and navigation flows between different website pages. Additionally or alternatively, primitive normalization engine 112 may identify other functions, such as event handler functions that trigger pop-ups, animations, and/or other operations upon mouse clicks or other events that may occur during test runtime. Primitive normalization engine 112 may parse metadata and/or code associated with a source element to determine what functions, if any, are associated with the element.

In other embodiments, primitive normalization engine 112 may receive a prototype in a non-normalized format (e.g., a format native to the prototype development tool used to create the prototype) as input and decompile the prototype into a set of one or more prototype primitives. For instance, a de-compilation process may convert a mockup or model of a user interface into a set of primitive components that may be recompiled to generate a prototype having the same visual elements and original functionality. The recompilation process may extend and/or modify the functionality of the source prototype as discussed further herein.

In some embodiments, the normalization process creates a set of prototype primitives that have a uniform format. The normalized format may define these visual characteristics differently than the source format. For instance, a mockup of a webpage may simply be a single image file representing how a final version of the page would appear when fully developed. The normalization process may parse the image and break it into various elements within the image, which may include shapes, regions, image portions, buttons, hotspots, and/or other primitives. The visual characteristics of a primitive may be encoded using a vector graphic format, such as a scalable vector graphic format, and/or encoded using some other schema that is compatible with the compiler and the test runtime environment to render and present prototypes to respondents.

A normalized primitive may be created in a manner that encodes the same visual characteristics (e.g., same size, color, page position, stroke width, opacity, etc.) as the source set of one or more elements (or portion of the source element mapped to the primitive). Thus, the runtime test environment may render the primitives in a manner that presents elements in the same visual arrangement as the source. In other cases, the look and feel may be similar but different. For instance, a set of wireframe prototype primitives may maintain the basic shape and arrangement of visual elements, but other visual details may not be retained. Primitives may further maintain the same functions as the source elements from which they are derived. Additionally or alternatively, the functions may be extended during compilation as described further below.

In the examples above, the prototype development tools initially generate prototypes in a non-normalized format that is converted to one that is compatible with prototype compiler 114. In other embodiments, a prototype development tool may directly allow prototypes to be defined using a pre-defined, normalized set of prototype primitives. For example, prototype development tool 206 may include an interface design editor that allows a web interface designer to create a website mockup using a normalized set of visual and functional components. In this case, prototype development tool 206 may export or compile the prototype primitives directly without an additional normalization step being performed.

As previously noted, the source of a prototype may be a website or application rather than a prototype of the website. For example, website 204 may be exported and normalized to create a set of prototype primitives. In this case, primitive normalization engine 112 may use a web crawler and/or scraper to identify the visual and functional elements of website 204. For example, primitive normalization engine 112 may scrape a cascading style sheet (CSS), hypertext markup language (HTML) code, JavaScript files, and/or other source code used by browser applications to render website 204. Primitive normalization engine 112 may map these components to prototype primitives. During normalization, several of the functions of the website may be ignored if not supported by the prototype primitives for a mockup or user interface model. Other functions, such as navigation flows between pages of the website, may be retained and normalized. For example, primitive normalization engine 112 may crawl a live web application to identify the user interface elements that form a given page and the navigation flow between different pages. A web crawler may scrape the information from the website code within the site's domain, creating a set of prototype primitives mapped to the identified user interface elements.

Prototype primitives may further be generated by processing screenshots of the website and mapping interactive hotspots to different regions of the image that trigger functions such as navigating to a different page. As previously noted, the normalized prototype primitives for a given site may not encapsulate all of the functionality of a live website. For instance, a prototype primitive for completing a purchase in a shopping cart application may not include functionality for triggering a backend payment processing service when selected. However, the prototype primitive may be clickable to navigate to a page as if the transaction was successfully completed. Other prototype primitives may also not encapsulate all of the functions of a fully developed website or application, even when the prototype primitives are derived directly from the site. Normalization facilitates processing by prototype compiler 114 and may allow for direct comparisons between interface designs at various stages of development.

Once the normalized primitives are generated, prototype compiler 114 performs compile operation 214 to generate prototypes 216. Prototype compiler 114 may use configurations 212 during compile operation 214 to determine (a) how many prototypes to configure for the input set of prototype primitives 210, and (b) how to compile the prototypes. In some embodiments, compiler 114 may inject code into a prototype for executing different functions depending on the configurations associated with the prototype. Example functions may include:
Task flow monitoring that tracks the current progress of a test respondent. Task flow monitoring may track how long a user takes on the task as a whole, how long to complete individual steps within the task flow, and/or how long to reach benchmarks within the task flow. Additionally or alternatively, task flow monitoring may track how many correct clicks/interactions the user has made and/or how many incorrect clicks/interactions the user has made to advance the task flow. Additionally or alternatively, task flow monitoring may track coordinates of user clicks to determine which user interface elements are receiving the most attention.
Task flow changes that reset, rewind, or fast forward a current flow of a respondent. For example, code may be injected with checkpoints within a navigation flow which test engine may jump to at runtime if predetermined conditions are met. The flow may jump forward to another screen in the flow to help a user advance or backward to have the user try again.
Prompt generation and management that presents information to test respondents during the test. For example, a respondent may be provided with a pop-up message or annotation with a hint to advance the current task flow. As another example, survey questions may be presented at one or more points along the flow, such as at the beginning, in the middle at one or more checkpoints, and/or at the end of completing a task.
Sentiment monitoring that gauges how interactions with a prototype engages users' emotions at various stages of a flow and with respect to various elements within the design.
Usability statistics monitoring that captures information about how a user interacts with a prototype, such as how long the user engages with a particular feature, what portions of the design receive the greatest number of interactions, how long it takes before a user first interacts with an element on a screen, how many clicks it took for the user to complete a task, and the ratio of correct to incorrect clicks for advancing a particular flow.
   Additionally or alternatively, prototype compiler 114 may add code for executing other functions, execution of which may trigger based on interactions between a test respondent and a compiled prototype.

The functions that are executed with respect to a compiled prototype may be customizable by a user, such as a prototype designer. In some embodiments, prototype development tool 206 includes an interface for defining functions and triggering events. For example, a user may input survey questions, prompts, annotations, hints, and/or other messages and the conditions under which to display the messages. The user may specify the message and conditions using plain text without requiring any complex coding. Prototype compiler 114 may take the configurations as input and generate/inject the code into a prototype to perform the custom functions. For instance, prototype compiler 114 may add event handler code that triggers a pop-up message or annotation responsive to detecting a click or other interaction with respect to a particular virtual element within a compiled prototype.

In some embodiments, compiler 114 may generate different compiled prototypes from the same set of one or more prototype primitives. Different compiled prototypes may be used at runtime for different purposes, such as to test different facets of a user experience and capture different usability information. Each compiled prototype may include a different set of code that is injected to execute functions associated with the prototype's purpose.

In some embodiments, the compiled prototypes include a navigable prototype and an annotatable prototype. The navigable prototype may be a task-oriented prototype that allows test respondents to navigate to different screens within a task flow by clicking on or otherwise selecting visual elements of the prototype. For example, the navigable prototype may include embedded code for executing the navigation functions responsive to detecting user's clicks at particular coordinates within the screen. The annotatable prototype may include the same set of screens. However, rather than including embedded code for executing the navigation functions, the annotatable prototype may include embedded code that allows users to click on and annotate various visual elements of a screen.

Additionally or alternatively, other types of compiled prototypes may be generated. For example, a compiled prototype may embed code for presenting survey questions and/or hints at various checkpoints among a task flow. Additionally or alternatively, different compiled prototypes may be generated for different tasks that may be performed using the same user interface mockup or model. Thus, the code that is embedded may be tailored to the task the test respondent is prompted to perform.

As another example, a sentiment-based prototype may prompt a user regarding how they feel about various design elements and/or infer the user's sentiment based on tracked interactions. In the latter case, for instance, the test framework may infer a negative sentiment if the user is taking too long to complete a task, has exceeded a threshold time to click on any item on the screen, has exceeded a threshold click rate by clicking too frequently, and/or has a threshold number of mis-clicks. Other compiled prototypes may also be generated for different purposes, which may vary from implementation to implementation.

### 4. Multi-Pass Usability Tests

Multiple compiled prototypes may be used to perform a multi-pass usability test for a particular digital asset in accordance with some embodiments. Test engine 120 may load a different compiled prototype on each pass and use the loaded prototype version to test/capture unique quantitative and/or qualitative data about various facets of a test respondent's experience with the user interface. For example, a two-pass test may perform a first pass to capture data measuring how a user performs on a given task, such as the length of time to complete the task, number of mis-clicks, etc. A second pass may capture sentiment information about how the respondent emotionally responded to various aspects of the design. Additionally or alternatively, other passes may be performed to test other task flows and/or capture other information about how users engage and respond to a user interface. The number of passes and compiled versions of an interface prototype may vary depending on the particular implementation.

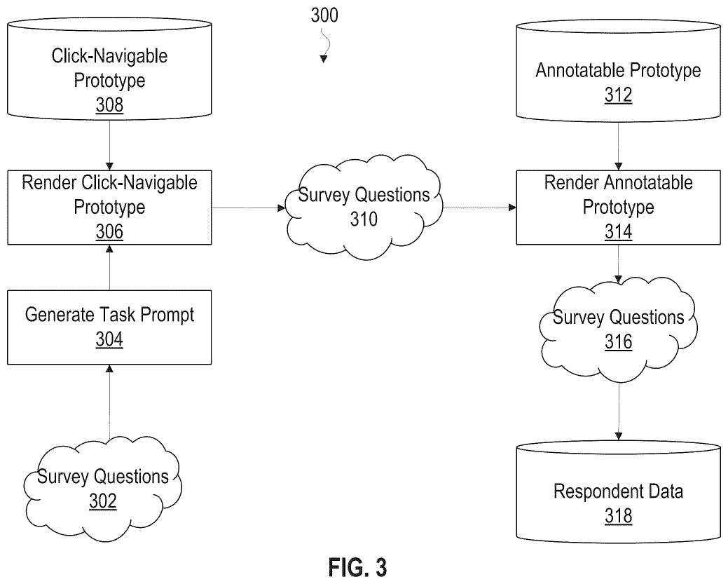

FIG. 3 illustrates example dataflow diagram 300 for performing multiple passes using different compiled versions of a prototype to capture various facets of a user experience in accordance with some embodiments. Referring to dataflow diagram 300, test engine 120 presents a set of survey questions 302 to a test respondent taking the usability test. The survey questions may establish background information about the respondent, such as demographic information, interests, qualifications, and/or other user attributes. In some cases, the survey questions may be used to screen users before allowing the user to proceed with the usability test. If the respondent does not satisfy a set of qualification criteria, then test engine 120 may terminate the test and/or otherwise block the user from proceeding further in the test process. If the respondent satisfies the criteria for taking the test, then the process may permit the respondent to proceed. Performing a screening may help prevent and mitigate fraud as some panel providers may receive remuneration based on the number of respondents that successfully completed a test.

Test engine 120 next generates a task prompt at operation 304. The task prompt may include instructions on the task that the user is requested to complete during the usability test. The prompt may include other information, such as time limits and/or other parameters associated with completing the task. In some embodiments, the survey questions and/or task prompt may be triggered based on code embedded in or otherwise associated with click-navigable prototype 308.

Test engine 120 further loads and renders click-navigable prototype 308 at operation 306. In some embodiments, click-navigable prototype 308 includes a set of frames that represent individual screens or pages of an app or website. The frames may be linked together with interactive hotspots or buttons, which may trigger actions such as navigating to another screen. Click-navigable prototype 308 may include embedded code (or code that is otherwise linked/associated with the prototype) for tracking click coordinates each time the user clicks or otherwise selects a location within a frame using an input device such as a mouse, touchpad, keyboard, or other user input device. Additionally or alternatively, click-navigable prototype 308 may include embedded code for performing one or more other functions, such as tracking task progress and statistics.

Once the task is complete, test engine 120 may further prompt the respondent with survey questions 310 to gauge how the user felt about the experience. For example, test engine 120 may prompt the user to describe positives and/or negatives of one or more facets of the mockup user interface design.

On a second pass, test engine 120 may load and render annotatable prototype 312 at operation 314. In some embodiments, annotatable prototype 312 is associated with code for prompting the user about sentiment-based information. For example, the code may cause test engine 120 to prompt the user to click on aspects of a screen that the respondent liked and disliked. For each click, test engine 120 may prompt the user to input a qualitative statement as to the reasons why the user liked or disliked the particular aspect. The user input may be used to decorate the prototype with annotations.

Additionally or alternatively, annotatable prototype 312 may include more targeted questions, such as specific questions for a particular facet of the user experience. For instance, the user may be prompted to click on aspects of a design that were the most intuitive and/or least intuitive. Other prompts may be presented to the user to click on aspects of the design that were most helpful and least helpful, most valuable and least valuable, most trusted and least trusted, etc.

Additionally or alternatively, annotations may also be computed based on tracked interactions between a respondent and the click-navigable prototype. For example, annotations may be added based on how long it took to complete various stages of a task. Tasks that took below a threshold amount of time may be inferred as intuitive, and tasks that took longer than the threshold may be inferred as unintuitive. The respondent may be allowed to review/update the annotations and be prompted for reasons why the user found the automatically labelled assets intuitive or not. As another example, the coordinates where a user clicked in the first pass of the test may be fed as input to the second pass. The annotatable prototype may generate prompts based on the coordinates, such as by asking which aspects of the display corresponding to the coordinate regions, the user liked or disliked. Thus, the attention of the user may be focused on the areas of the interface design with which the respondent actually engaged.

Once annotations are complete, test engine 120 may further prompt the respondent with survey questions 316 to gather additional information. For example, test engine 120 may prompt the user for overall sentiment about the test and/or design. Once the respondent completes the survey, the responses, tracked interactions, and behavioral data are packaged as respondent data 318, which may be retained in a data repository for subsequent analysis.

The example depicted in FIG. 3 illustrates an example two-pass method. However, as previously noted, the number of passes may vary depending on the particular implementation. For example, a single pass may be performed using a single prototype with extended functionality added through the compilation process. In other cases, more than two passes may be executed during a test to test other additional facets of user experiences with a particular digital asset design. The compiled prototypes that are used at each test phase may vary in form and function.

### 5. Analytics and Result Processing

In some embodiments, result processing engine 122 generates a visual analysis of a prototype based on the test results from multiple respondents. For example, result processing engine 122 may aggregate information about what areas of the user interface were most frequently clicked on, what percentage of respondents viewed each aspect positively and negatively, and why the respondents liked or disliked different elements of the user interface design. Result processing engine 122 may add overlays, annotations, and/or other visual elements to a prototype based on the analysis of the results.

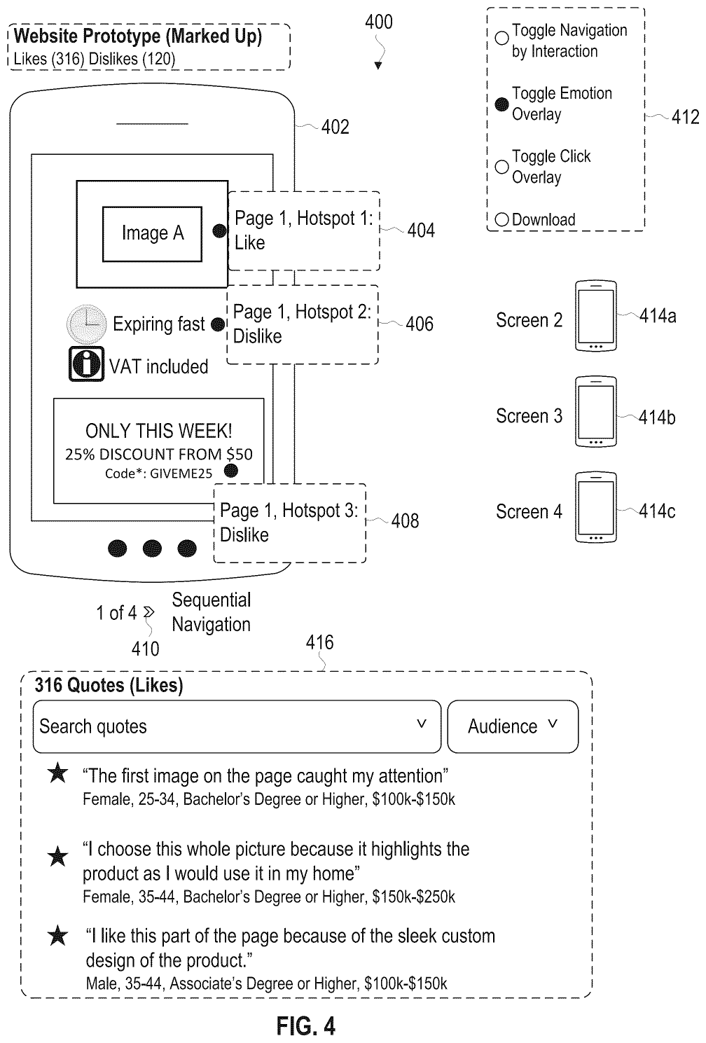

FIG. 4 illustrates an example set of prototype images that are decorated based on the results of running multi-pass usability tests in accordance with some embodiments. Result interface 400 shows image 402 from a first screen of a decorated website prototype. The screen is decorated with annotations 404, 406, and 408. The annotations correspond to different elements within screen where users clicked and show the overall sentiment of each element.

Interface control 412 allows the user to toggle various decorations, including annotations and overlays. In the example illustrated, the designer may toggle between an emotion overlay (likes or dislikes), a click overlay, and a view that presents qualitative responses that are relevant to a selected sentiment.

The emotion overlay highlights which element or regions within the currently viewed frame/screen image respondents liked and disliked. In some embodiments, the overlay may present emotions in different colors. For example, likes may be presented in green and dislikes may be presented in red. The intensity of the color and/or size of a visual element may vary depending on how many likes or dislikes the area received to draw the designer's focus to the design areas receiving the most positive or negative attention.

The click overlay highlights which element or regions within the currently viewed frame/screen image where respondents have clicked. Similar to the emotion overlay, the click overlay may be presented as a heatmap based on the number and/or frequency of clicks. Thus, the color of a region in the overlay may vary by hue or intensity to provide visual cues to which areas of the display received the most attention in terms of clicks. Additionally or alternatively, emotions may be presented using other charts (e.g., bar charts, radar charts, etc.) or visual indicators (e.g., annotations, highlights, etc.).

Result interface 400 further includes navigation control 410, which allows the designer or analyst to switch between different screens of the website, including screens 414a-c. Responsive to clicking navigation control 410, screen 402 in the main display is replaced by the next screen in the sequence. The selected overlays and/or annotations may be applied to the next screen based on the test results associated with the screen. Thus, the user may view other screens with the overlays that match the single view settings, allowing the user to easily toggle between the specifics of a single view and the aggregate experience.

Tile 416 presents qualitative responses that are relevant to a selected emotion. In the present example, the user has selected “Likes” for the website prototype. In response, the qualitative reasons respondents liked the design are presented. The user may sort the responses by audience and/or other attributes, such as the element in the user interface design with which the quote is associated. The user may perform a keyword search to find quotes relating to a specific topic. Details about the individual respondents are included for each qualitative response.

In some embodiments, result interface 400 may include recommended changes based on the processed test results. For example, result interface 400 may recommend an update, such as moving a user interface element to a different location of the screen or removing a user interface element, based on the dislikes and qualitative responses indicating a reason for the dislikes. Result interface 400 may provide a link to an editor to make the requested change and/or may include a selectable link that, when click, performs the recommended update.

Additionally or alternatively, result interface 400 may generate a comparison of the prototype with one or more other prototype and/or live sites. A report may compare quantitative and/or qualitative comparisons of the results obtained from one or more passes for a design of interest (the target design) and one or more reference designs. The same test code may be injected into the compiled prototypes of the target design and the one or more reference design to provide a normalized basis of comparison. The comparison results may provide various insights such as which design is liked more as a whole, what aspects of the target design performed better than a reference design, what aspects of the target design performed worse, why the target design and individual components therein were liked more or less than a reference design, and what changes are predicted (e.g., by a machine learning process) to address discrepancies between the test results.

### 6. Dynamic and Programmatic Flow Changes

As previously noted, test framework 110 may provide the ability to programmatically change flows in a prototype based on a user's interaction with the prototype. For example, if the user is mis-clicking or getting stuck, then test engine 120 may prompt the user with one or more questions to help understand the reason for the stall. Additionally or alternatively, test engine 120 may reset, rewind, or fast forward the respondent's progress based on the test design and/or level of respondent frustration. As another example, test engine 120 may inject annotations to help focus a respondent's attention on a given region or particular element within the frame.

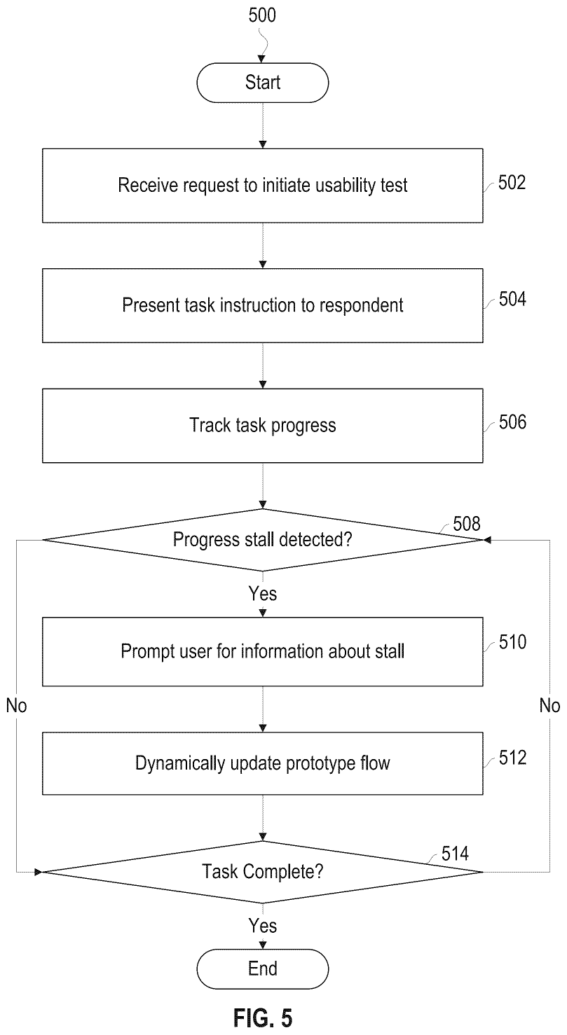

FIG. 5 illustrates example process 500 for programmatically changing the flow of a prototype in accordance with some embodiments. Process 500 includes receiving request to initiate a usability test (operation 502). For example, a respondent may select a hyperlink to generate a Hypertext Transfer Protocol (HTTP) request to a server running test engine 120. In response, test engine 120 may screen the candidate respondent and, if successfully screened, initiate the test by loading and rendering a compiled prototype.

Process 500 further presents one or more task instructions to the respondent (operation 504). For example, a prompt for a mobile stock trading app may instruct the client to sell a call option. A prompt for an e-retail website may prompt the user to complete a return. As may be appreciated, the tasks may vary significantly depending on the particular digital asset under test.

Once the test has been initiated, process 500 tracks the respondent's progress (operation 506). For example, process 500 may track how many clicks have been made by the respondent and the coordinate locations of the clicks. Process 500 may maintain an expected set of clicks for a given task flow to determine how many times the respondent has mis-clicked and clicked correctly. Additionally or alternatively, process 500 may track the progress using other metrics, such as how long the respondent has taken on a given stage of the task and the aggregate amount of time the respondent has taken on the task.

Based on the tracked progress, process 500 determines whether a progress stall is detected (operation 508). In some embodiments, process 500 may determine whether there is a stall or not based on the number or frequency of mis-clicks. If the number or frequency exceeds a threshold, then process 500 may detect a stall. Additionally or alternatively, process 500 may determine whether there is a stall based on the amount of time the user has taken with respect to a given stage of a task flow. If the time exceeds a threshold, then a stall may be detected. Additionally or alternatively, stalls may be detected using other parameters, such as if there is greater than a threshold amount of time between user clicks.

If a stall is detected, then process 500 prompts the user for information about the stall (operation 510). For example, process 500 may prompt the user to input a quote detailing the reason for the stall. Additionally or alternatively, process 500 may prompt the user to select elements within the frame that are causing confusion. Process 500 may record the information as part of the packaged respondent test results.

Additionally or alternatively, when a stall is detected, then process 500 dynamically updates the prototype flow (operation 512). As previously noted, process 500 may inject an annotation, which may include a verbal and/or visual hint to completing the next step of the task. As another example, process 500 may reset or rewind the flow to a previous checkpoint where the user was on the right track and prompt the respondent to try again. Alternatively, process 500 may fast forward to skip steps and advance the user in the task flow. Fast forwarding or rewinding the flow may take the user to another frame within the prototype. A prompt may be presented to the user to notify the user that the test has jumped ahead or reset to a prior state. In other cases, the user may be skipped ahead to the end of the test or the user may be kicked out of the test, terminating the task flow.

Process 500 may continue until it determines that the task is complete (operation 514). Once the task is complete, the test may continue to the next phase, if one exists, or the respondent results may be packaged as previously described.

### 7. Computer Networks and Cloud Networks

In some embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as HTTP. The requests are communicated through an interface, such as a client interface (such as a web browser), a program interface, or an application programming interface.

In some embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In some embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In some embodiments, in a multi-tenant computer network, tenant isolation is implemented to ensure that the applications and/or data of different tenants are not shared with each other. Various tenant isolation approaches may be used.

In some embodiments, each tenant is associated with a tenant ID. Each network resource of the multi-tenant computer network is tagged with a tenant ID. A tenant is permitted access to a particular network resource only if the tenant and the particular network resources are associated with a same tenant ID.

In some embodiments, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In some embodiments, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In some embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Microservice Applications

According to some embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using Hypertext Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In some embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to some embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In some embodiments, a plugged-in microservice application may expose actions to the microservices manager. The exposed actions may receive, as input, data or an identification of a data object or location of data, that causes data to be moved into a data cloud.

In some embodiments, the exposed actions may receive, as input, a request to increase or decrease existing alert thresholds. The input might identify existing in-application alert thresholds and whether to increase or decrease, or delete the threshold. Additionally or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In some embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

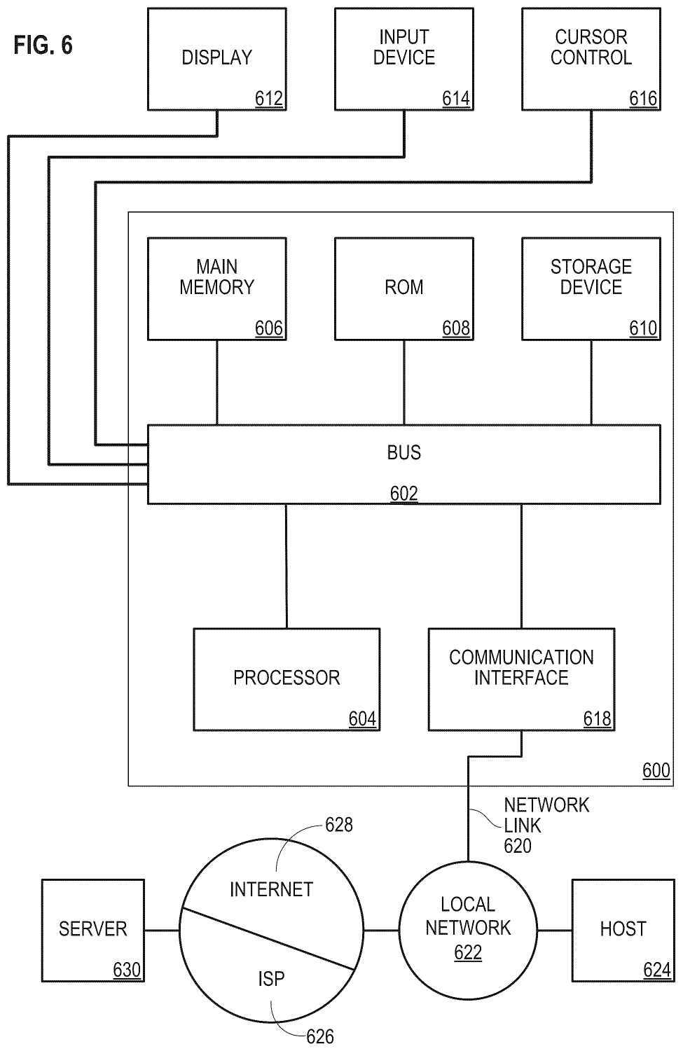

For example, FIG. 6 illustrates a computer system in accordance with some embodiments. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 12. Miscellaneous; Extensions

Embodiments are directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims. Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. One or more non-transitory computer-readable media storing instructions which, when executed by one or more hardware processors cause:
identifying a first prototype or a developed user interface design;
extracting a set of design elements from the first prototype or the developed user interface design;
generating, as a function of the set of design elements extracted from the first prototype or developed user interface design, a set of one or more normalized primitives that are compatible with a prototype compiler for generating new prototypes, wherein each normalized primitive in the set of one or more normalized primitives defines visual characteristics of at least one design element of the set of design elements extracted from the first prototype or the developed user interface design in a different format than defined by the first prototype or the developed user interface design wherein generating the set of one or more normalized primitives includes decompiling the first prototype or developed user interface design into a source set of one or more primitives and converting the source set of one or more primitives to a normalized format for encoding the visual characteristics of the at least one design element;
generating, by the prototype compiler, a second prototype by compiling the set of one or more normalized primitives, wherein compiling the set of one or more normalized primitives includes adding, by a compiler, code to the second prototype for executing at least one function that was not included in the first prototype or the fully developed user interface design, wherein the second prototype generated by the prototype compiler by compiling the set of one or more normalized primitives includes a set of linked frames and is not a fully developed user interface.

2. (canceled)

3. The media of claim 1, wherein the prototype compiler determines what code to add based at least in part on a set of configuration settings.

4. The media of claim 1, wherein the at least one function includes code for tracking clicks within one or more frames of the second prototype.

5. The media of claim 1, wherein the at least one function includes code for programmatically changing a flow associated with the first prototype.

6. (canceled)

7. The media of claim 1, wherein the developed user interface design is a live website; wherein generating the set of one or more normalized primitives comprises: identifying, by a web crawler, a set of components on the live website; and mapping each component in the set of one or more components to at least one normalized primitive.

8. The media of claim 1, wherein the instructions further cause: generating a third prototype by compiling the set of one or more normalized primitives; wherein a compiler adds a different set of functions to the third prototype than the second prototype; wherein the different set of functions are associated with capturing information about at least one facet of user experiences with the user interface design.

9. The media of claim 1, wherein the instructions further cause: executing a test associated with the user interface design using the second prototype; wherein executing the test comprises: executing the at least one function responsive to at least one interaction between a respondent and the second prototype.

10. The media of claim 9, wherein the instructions further cause: presenting a result associated with executing the test associated with the user interface design that identifies at least one issue associated with the user interface design.

11. One or more non-transitory computer-readable media storing instructions which, when executed by one or more hardware processors cause:
compiling, by a prototype compiler, a same set of input primitives for a user interface design multiple times to generate a plurality of prototypes for testing the user interface design in a multi-pass test, wherein the prototype compiler embeds or associates different code with each different compiled prototype of the plurality of prototypes, wherein the prototype compiler determines how many prototypes to compile and what types of prototypes to compile based on a set of configurations, wherein the plurality of prototypes includes at least a first prototype for testing a first set of one or more facets of the user interface design and a second prototype for testing a second set of one or more facets of the user interface design;
executing the multi-pass test associated with the user interface design using the plurality of prototypes, wherein executing the test includes presenting, in a first pass, the first prototype to at least one respondent to test the first set of one or more facets of the user interface design and presenting, during a second pass subsequent to the first pass, the second prototype to the at least one respondent to test the second set of one or more facets of the user interface design, wherein the first prototype is a navigable prototype comprising a set of linked frames or pages, wherein the second prototype is an annotatable prototype; wherein the first prototype navigates to another frame or page responsive to a respondent selecting a particular region of the frame or page; wherein the second prototype prompts a user to decorate the prototype responsive to the respondent selecting the particular region of the frame or page; and
presenting a result associated with executing the multi-pass test associated with the user interface design that identifies at least one issue associated with the user interface design.

12. (canceled)

13. The media of claim 11, wherein the first prototype design is associated with a first set of one or more functions for testing the first set of one or more facets and the second prototype design is associated with a second set of one or more functions for testing the second set of one or more facets.

14. (canceled)

15. The media of claim 11, wherein the first prototype tracks progress of the at least one respondent with respect to a particular task; wherein the second prototype captures sentiment of the at least one respondent.

16. The media of claim 15, wherein the instructions further cause: determining that the progress of the at least one respondent has stalled; and responsive to determining that the progress of the at least one respondent has stalled, programmatically changing a flow in the first prototype.

17. The media of claim 11, wherein presenting the result comprises: generating an overlay based at least in part on sentiment information captured for the at least one respondent; presenting an image of the user interface design with the overlay; wherein the overlay identifies at least a first element of the user interface design associated with a positive sentiment and at least a second element of the user interface design associated with a negative sentiment.

18. The media of claim 11, wherein presenting the result comprises: generating an overlay based at least in part on how frequently different regions of the user interface design were clicked by different respondents; presenting an image of the user interface design with the overlay; wherein the overlay identifies which regions were clicked most frequently by the different respondents.

19. The media of claim 11, wherein presenting the result comprises: presenting a set of captured responses from the at least one respondent indicating a reason why a particular aspect of the user interface design was liked or not liked.

20. A method comprising:
identifying a first prototype or a developed user interface design;
extracting a set of design elements from the first prototype or the developed user interface design;
generating, as a function of the set of design elements extracted from the first prototype or developed user interface design, a set of one or more normalized primitives that are compatible with a prototype compiler for generating new prototypes, wherein each normalized primitive in the set of one or more normalized primitives defines visual characteristics of at least one design element of the set of design elements extracted from the first prototype or the developed user interface design in a different format than defined by the first prototype or the developed user interface design wherein generating the set of one or more normalized primitives includes decompiling the first prototype or developed user interface design into a source set of one or more primitives and converting the source set of one or more primitives to a normalized format for encoding the visual characteristics of the at least one design element;
generating, by the prototype compiler, a second prototype by compiling the set of one or more normalized primitives, wherein compiling the set of one or more normalized primitives includes adding, by a compiler, code to the second prototype for executing at least one function that was not included in the first prototype or the fully developed user interface design, wherein the second prototype generated by the prototype compiler by compiling the set of one or more normalized primitives includes a set of linked frames and is not a fully developed user interface.

21. A method comprising:
compiling, by a prototype compiler, a same set of input primitives for a user interface design multiple times to generate a plurality of prototypes for testing the user interface design in a multi-pass test, wherein the prototype compiler embeds or associates different code with each different compiled prototype of the plurality of prototypes, wherein the prototype compiler determines how many prototypes to compile and what types of prototypes to compile based on a set of configurations, wherein the plurality of prototypes includes at least a first prototype for testing a first set of one or more facets of the user interface design and a second prototype for testing a second set of one or more facets of the user interface design;
executing the multi-pass test associated with the user interface design using the plurality of prototypes, wherein executing the test includes presenting, in a first pass, the first prototype to at least one respondent to test the first set of one or more facets of the user interface design and presenting, during a second pass subsequent to the first pass, the second prototype to the at least one respondent to test the second set of one or more facets of the user interface design, wherein the first prototype is a navigable prototype comprising a set of linked frames or pages, wherein the second prototype is an annotatable prototype; wherein the first prototype navigates to another frame or page responsive to a respondent selecting a particular region of the frame or page; wherein the second prototype prompts a user to decorate the prototype responsive to the respondent selecting the particular region of the frame or page; and
presenting a result associated with executing the multi-pass test associated with the user interface design that identifies at least one issue associated with the user interface design.

22. The method of claim 21, wherein the first prototype design is associated with a first set of one or more functions for testing the first set of one or more facets and the second prototype design is associated with a second set of one or more functions for testing the second set of one or more facets.

23. The method of claim 21, wherein the first prototype tracks progress of the at least one respondent with respect to a particular task; wherein the second prototype captures sentiment of the at least one respondent.
